(19) United States
(12) Patent Application Publication
(10) Pub. No.: US 2018/0111793 A1
(43) Pub. Date: Apr. 26, 2018

(54) Building Traffic Analyzer

(71) Applicant: Otis Elevator Company, Farmington, CT (US)

(72) Inventors: Hiromitsu Miyajima, Inzai (JP); Atsushi Yamada, Narita-shi (JP); Hideyuki Honma, Inzai (JP); Kenichi Ohmura, Yotsukaido (JP); Osamu Sakai, Tomisato (JP)

(21) Appl. No.: 15/298,633

(22) Filed: Oct. 20, 2016

(51) Int. Cl. B66B 5/00; B66B 19/00; G07C 1/04

(52) U.S. Cl. CPC B66B 5/0012; G07C 1/04; B66B 5/0018; B66B 19/007

(57) ABSTRACT

An exemplary building traffic analyzer for an elevator includes: a video camera arranged in an elevator car; a traffic analyzer unit for collecting traffic data of passengers through the video camera; and a data storage unit for storing the traffic data of passengers collected by the traffic analyzer unit. The traffic analyzer unit is configured to identify and track each passenger for collecting the traffic data of each passenger including a boarding floor with boarding time and a destination floor with exiting time. The building traffic analyzer is configured to be temporarily attachable in the elevator car, such as on the ceiling or proximity to the elevator control panel.

### TECHNICAL FIELD

The present invention relates to a building traffic analyzer for an elevator. In particular, the present invention relates to a building traffic analyzer that can be temporarily attached to an elevator car for collecting passenger traffic information.

### BACKGROUND ART

In general, the traffic volume of an elevator varies depending on the scale of a building in which the elevator is installed, or the number of tenants in the building. Further, if an elevator is installed in an office building, the traffic volume also varies during certain time periods on weekdays or holidays. When there is a need for operating an elevator to meet the need of a customer, such as a building owner or a building administrative company, or optimizing the elevator control system, or when the replacement of the elevator system itself is carried out, it is necessary to analyze the real traffic data, i.e. the flow of passengers of the elevator over a certain period of time, such as for one week or one month.

For example, JP-A-04-308174 discloses a method of detecting the number of passengers by using the information from car load detecting device. The method is to count the rough number of the passengers boarding and exiting the elevator car at each floor, which is calculated by using the variation amount of the in-car weight from the opening start time of the elevator door to the closed completion of the door.

However, in the above-mentioned method, it is not possible to collect the exact number of the boarding/exiting passengers at each floor, even though it is possible to count the approximate number of the boarding/exiting passengers. In particular, when measuring the number of passengers from the in-car weight data, since the number of the passengers are usually derived from the average body weight, some errors may be observed in a case such as when three adults get off the elevator and then three children get on the elevator at the same floor. In addition, in the conventional method, it is not possible to track the actual flow of the passengers, e.g. when and what floor does a passenger get on the elevator car and then when and what floor does he/she get off the elevator car.

When analyzing the flow of the elevator passengers using such data, it is usually performed by creating a virtual data of all passengers, including what time and what floor each passenger gets on the elevator at and then what time and what floor the passenger gets off the elevator at, based on the collected data of the number of boarding/exiting passengers at each floor, followed by inputting the virtual data to a simulation software or by analyzing the virtual data manually. Therefore, the accurate traffic information cannot be obtained from the simulation of the traffic volume based on the data obtained from load variation of the passengers, because the actual information of each passenger, especially when and what floor he/she gets on the elevator car and then when and what floor he/she gets off the elevator car, is unknown from the in-car weight data.

In order to count the actual number of passengers, it is necessary to conduct a research using manpower by allocating researchers at each floor. However, such method is costly and inefficient in extracting and inputting accumulated data. In addition, as is the case with the method using load detection device, it is not possible to track the actual flow of the passenger regarding what floor a passenger gets on the elevator car at and what floor he/she gets off at.

### SUMMARY OF INVENTION

According to one aspect of the present invention, a building traffic analyzer for an elevator includes: a video camera arranged in an elevator car; a traffic analyzer unit for collecting traffic data of passengers through the video camera; and a data storage unit for storing the traffic data of passengers collected by the traffic analyzer unit. The traffic analyzer unit is configured to identify and track each of all passengers for collecting the traffic data of each passenger, including a boarding floor with boarding time and a destination floor with exiting time. The building traffic analyzer in accordance with the present invention is configured to be temporarily attachable in the elevator car, such as on the ceiling or proximity to the elevator control panel.

In some embodiments, the video camera is an existing surveillance camera disposed on the ceiling of the elevator car, and the traffic analyzer unit is connected to the existing surveillance video camera.

In some embodiments, the traffic analyzer unit is connected between the existing surveillance camera and a video recorder of the surveillance camera via splitter.

In some embodiments, the traffic analyzer is connected to a control panel in the elevator car through a wiring in order to obtain position information of the elevator car from the control panel.

In some embodiments, the traffic analyzer further comprises a sensor for obtaining position information of the elevator car.

In some embodiments, the sensor is an atmospheric pressure sensor.

In some embodiments, the video camera is a three-dimensional camera.

According to another aspect of the present invention, a method of analyzing a flow of passengers in a building using a building traffic analyzer for elevator is disclosed. The building traffic analyzer includes: a traffic analyzer unit for collecting traffic data of passengers through a video camera; and a data storage unit for storing the traffic data of passengers collected by the traffic analyzer unit. The method includes the steps of: installing the building traffic analyzer in the elevator car; collecting traffic data of each passenger including a boarding floor with boarding time and a destination floor with exiting time by identifying and tracking the each passenger through the video camera; storing the traffic data of each passenger in the data storage unit; extracting the traffic data from the data storage unit; and analyzing actual traffic flow of the passengers in the building based on the traffic data obtained by the building traffic analyzer.

In some embodiments, the video camera is an existing surveillance camera in the elevator car, and the step of installing the building traffic analyzer further includes connecting the building traffic analyzer to the existing surveillance camera in the elevator car.

In some embodiments, the traffic analyzer is connected between the existing surveillance camera and a video recorder of the surveillance camera via splitter.

In some embodiments, the step of installing the building traffic analyzer further includes: connecting the building traffic analyzer to a control panel in the elevator car; and obtaining position information of the elevator car from the control panel.

In some embodiments, the step of analyzing the actual traffic flow of the passengers in a building further comprises inputting the traffic data to an external computer for simulation.

In some embodiments, the traffic analyzer further comprises an atmospheric pressure sensor for obtaining position information of the elevator car.

In some embodiments, the step of collecting traffic data of each passenger may be carried out for a predetermined period of time, e.g. for one week.

By using the building traffic analyzer according to the present invention, more accurate analysis for a traffic flow of passengers in a building for a survey period can be achieved, based on identifying and tracking each passenger regarding when and what floor each passenger gets on the elevator car and then when and what floor he/she gets off the elevator car.

These and other aspects of this disclosure will become more readily apparent from the following description and the accompanying drawings, which can be briefly described as follows.

### BRIEF DESCRIPTION OF DRAWINGS

FIG. 1 is a schematic view showing one possible arrangement of a traffic analyzer according to the present invention mounted on the ceiling of an elevator car.

FIG. 2 is a schematic view illustrating a method of tracking each passenger using the traffic analyzer in accordance with the present invention.

FIG. 3 is a flowchart showing a method of analyzing the flow of passengers of an elevator using the traffic analyzer in accordance with the present invention.

FIG. 4 are graphs for analyzing the number of passengers moved from lobby floor to the 12th floor in a building on weekdays.

### DESCRIPTION OF EMBODIMENTS

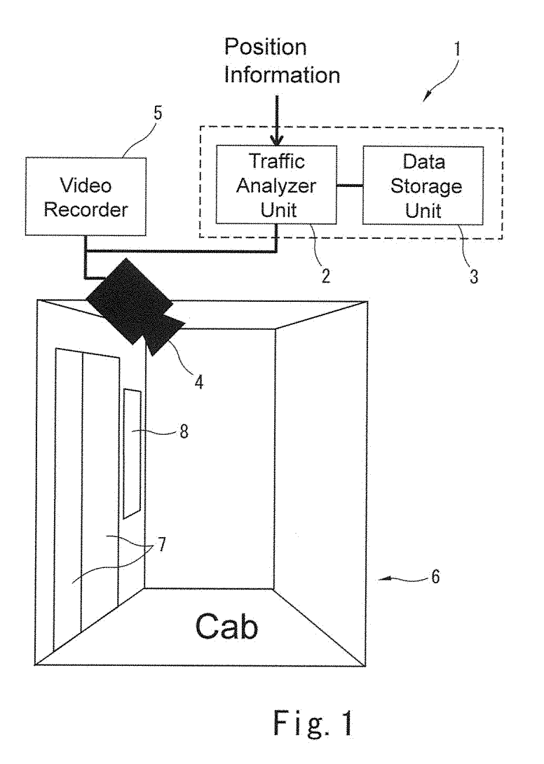

FIG. 1 is a schematic view showing an embodiment of a traffic analyzer 1 according to the present invention mounted on the ceiling of an elevator car 6. As shown in FIG. 1, the traffic analyzer 1 includes a traffic analyzer unit 2 and a data storage unit 3. The traffic analyzer 1 is connected between an existing surveillance camera 4 and a video recorder 5 installed in the elevator car 6 via a splitter (not shown) in order to obtaining image information from the existing surveillance camera 4. Further, the traffic analyzer 1 is connected to a control panel 8 via wirings (not shown) such that the traffic analyzer 1 operates from a power supply within the control panel 8 and obtains position information from the control panel 8. It should be understood that the traffic analyzer 1 may be configured to be connected to a power outlet arranged in the elevator car 6, the connecting terminal of the lighting and the like. Moreover, the traffic analyzer 1 may be configured to work either on batteries or AC current. It should also be understood that the image information of the surveillance camera 4 may be obtained from the control panel 8 or any available means.

Alternatively, the traffic analyzer 1 may be equipped with a video camera for analyzing the flow of passengers on the elevator car 6 so that the traffic analyzer 1 can be applicable to all types of elevators that do not have a surveillance camera. It should also be understood that any type of camera may be used as a video camera including, but not limited to, a conventional two-dimensional video camera, a three-dimensional video camera, a time-of-flight (TOF) camera and the like. Specifically, three-dimensional camera such as TOF camera is preferred in that it is capable of recognizing the information of passengers as a stereoscopic image with depth and thus the traffic analyzer unit 2 can accurately track passengers getting on and off at each floor even if some passengers are hidden behind other passengers at the time of congestion.

Alternatively, the traffic analyzer 1 may be equipped with an atmospheric pressure sensor or any other position information sensor for obtaining position information regarding what floor the elevator car 6 is on without having to connect the traffic analyzer 1 to the control panel 8 of the elevator car 6.

Furthermore, as described later, the data storage unit 3 is configured to store passenger information that the traffic analyzer unit 2 has collected. The collected and stored information of the passengers can be transmitted to an external device such as a PC, a portable device or any other devices via a wireless communication including, but not limited to, Wi-Fi and Bluetooth, or via a wired connection such as Ethernet, a USB connection and the like, for allowing researchers to collect stored data, if necessary. Moreover, the traffic analyzer 1 may be configured to transfer passenger information stored in the data storage unit 3 at all times through communication network to researchers. The data storage unit 3 may comprise any memory device well-known in the art.

The traffic analyzer 1 in accordance with the present invention is a relatively compact, light weight structure configured to be temporarily attachable to any position in the elevator car. In FIG. 1, although it has been shown that the traffic analyzer 1 is arranged near the surveillance camera 4 on the ceiling of the elevator car 6, the traffic analyzer 1 may be fixedly disposed on any position within the elevator car 6 as long as the traffic analyzer 1 is attached to a position that allows for an easy access to the surveillance camera 4 and the control panel 8. For example, the traffic analyzer 1 may be fixedly arranged proximity to the control panel 8 with the use of attachments (not shown).

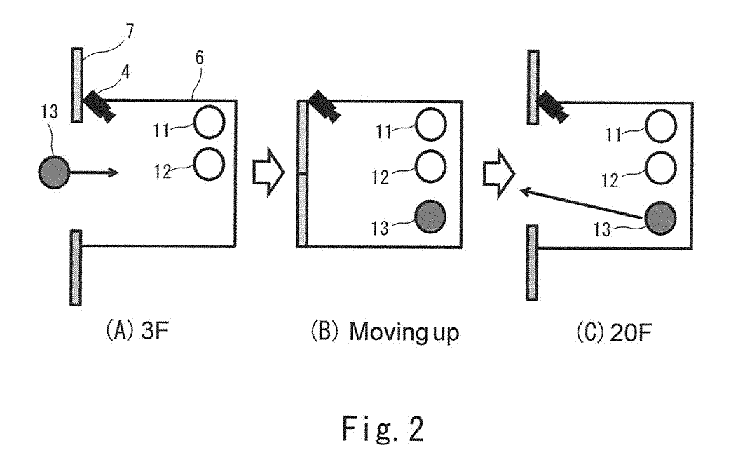

FIG. 2 illustrates a method of tracking each passenger using the traffic analyzer 1 in accordance with the present invention. For example, as shown in FIG. 2 (A), there are two passengers 11, 12 in the elevator car 6. When the elevator car 6 is stopped at the 3rd floor and the video camera 4 recognizes that a new passenger 13 gets on the elevator car 6 at the 3rd floor, the traffic analyzer unit 2 identifies the passenger 13 and stores the information in the data storage unit 3 about what time the passenger 13 gets on the elevator car 6 at the 3rd floor. During moving up of the elevator car 6 (FIG. 2 (B)), the traffic analyzer unit 2 tracks each of three passengers 11, 12, 13 independently. When the elevator car 6 stops at the 20th floor (FIG. 2 (C)) and the traffic analyzer unit 2 recognizes that the passenger 13 gets off the elevator car at the 20th floor, the traffic analyzer unit 2 stores the information in the data storage unit 3 about what time the passenger 13 gets off the elevator car 6 at the 20th floor.

Likewise, the traffic analyzer unit 2 tracks and stores the same traffic data about the rest of two passengers 11, 12. Namely, the traffic analyzer unit 2 identifies each of all passengers 11, 12, 13 in the elevator car 6 and stores the information of all passengers 11, 12, 13 in the data storage unit 3 regarding what time and what floor each passenger gets on and off the elevator car at. All this data may be stored in the data storage unit 3 for a period of time during the survey period, such as for one week, one month, etc.

By using the traffic analyzer 1 in accordance with the present invention, not only the number of the boarding/exiting passengers at a certain floor at a certain date and time can be collected, but the actual flow of all passengers in a building for a certain period of time, average service time for each passenger, the frequency of use of the elevator at each floor, and the occupancy rate of the elevator car can be analyzed based on the stored data.

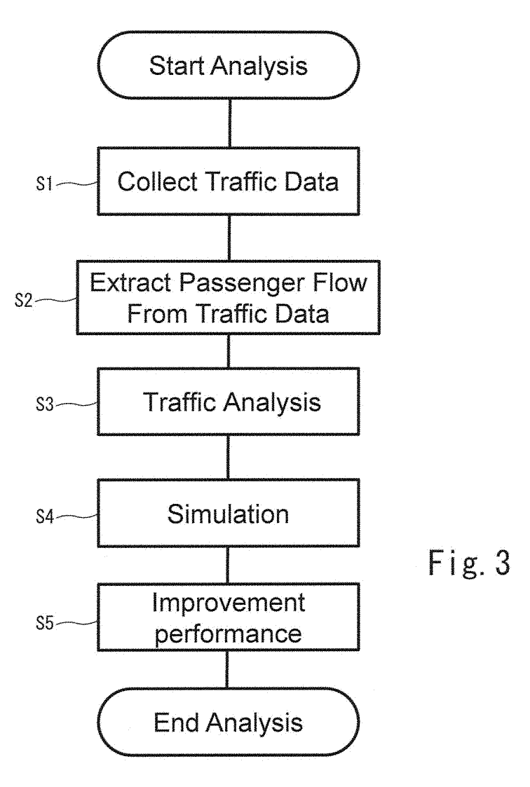

FIG. 3 illustrates a method of analyzing the flow of passengers of an elevator using the traffic analyzer 1 in accordance with the present invention. When the traffic analyzer 1 is installed in the elevator car 6, the traffic analyzer unit 2 starts analysis.

As described with reference to FIG. 2, the traffic analyzer unit 2 then tracks and collects traffic data of all passengers on the basis of image information from the surveillance camera 4 (Step 1). In other words, the traffic analyzer unit 2 identifies each of all passengers and stores the traffic data of all passengers in the data storage unit 3 regarding what time and what floor each passenger gets on and off the elevator car at. In one embodiment, the traffic data may be collected for a period of time during the survey period, such as for one week.

In this embodiment, after one week of the survey period, the traffic analyzer 1 is detached from the elevator car 6 and collected by a researcher to extract the traffic data of the passengers from the data storage unit 3 in the traffic analyzer 1 (Step 2). Alternatively, the traffic data of the passengers stored in the data storage unit 3 may be automatically uploaded to a remote database system or remote management sites via a communication network such as Internet over a survey period.

Subsequently, the actual flow of passengers is analyzed by inputting the data extracted from the traffic analyzer 1 to an external computer (Step 3). In one embodiment, the traffic data of all passengers, regarding when and what floor each of all passengers gets on and off the elevator car, is input to an external computer for analyzing the actual traffic flow of the passengers for one week period.

However, any traffic analysis can be carried out depending on the type of necessary information. For example, the exact number of passengers moved from the lobby floor to each floor of the building on weekday mornings may be analyzed from the traffic data stored in the traffic analyzer 1 for a survey period. The exact number of passengers moved from each floor to the lobby floor on weekday evenings may also be analyzed. In the present invention, by configuring the traffic analyzer 1 to record traffic data of all passengers along with the boarding/exiting time information of all passengers for a survey period, the necessary information can be retrieved from the accumulated data for the subsequent simulation.

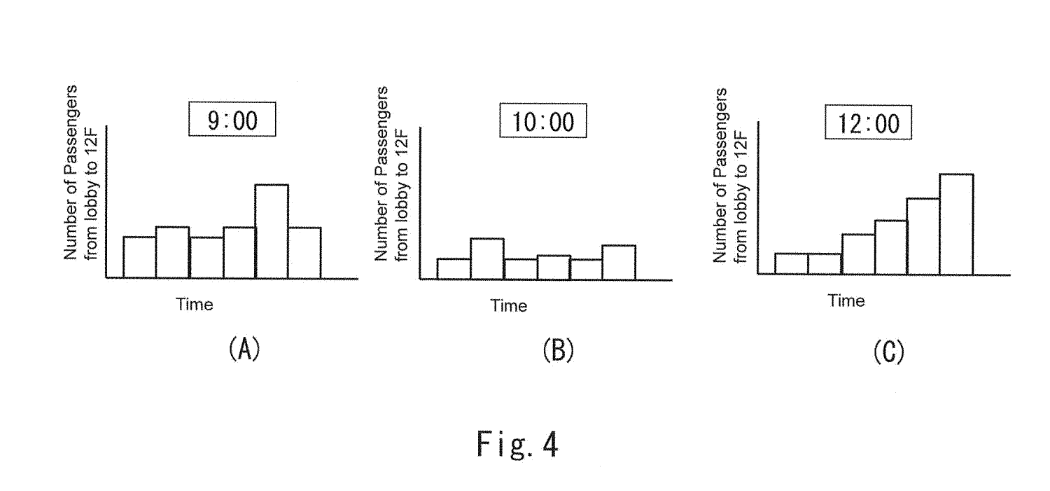

For example, FIG. 4 illustrates graphs for analyzing the number of passengers moved from lobby floor to the 12th floor on weekdays, with a vertical axis representing the number of passengers and a horizontal axis representing a time (at each 10 minutes interval). As shown in FIG. 4 (A), it will be seen that there are many passengers moving from the lobby floor to the 12th floor between 9:40 am to 9:50 am, and as shown in FIG. 4 (C), the number of passengers moving from the lobby floor to the 12th floor gradually increases from 12:20 pm to 1:00 pm. In contrast, as shown in FIG. 4 (B), there are relatively few passengers moving from the lobby floor to the 12th floor between 10:00 am to 11:00 am. From this analysis, the best timing for preferentially dispatching elevators to the lobby floor can be predicted.

Again referring to FIG. 3, based on the traffic data of the passengers regarding when and what floor each passenger gets on and off the elevator car, a simulation can be carried out (Step 4). This simulation may be carried out using simulation software for simulating a traffic flow of passengers in a building for a survey period. It may also be carried out by extracting only the necessary information from the accumulated data for analysis and then inputting the selected data to simulation software.

Conventionally, the actual traffic flow of each passenger could not have been tracked, regarding when and what floor each passenger gets on the elevator car and then when and what floor he/she gets off the elevator car. For this reason, when analyzing the flow of the elevator passengers using a conventional technique, it is usually analyzed by creating a virtual data of each passenger, including what time and what floor each passenger gets on the elevator at and then what time and what floor the passenger gets off the elevator at, based on the accumulated data of the number of boarding/exiting passengers at each floor, followed by inputting the virtual data to a simulation software or by analyzing the virtual data manually. In contrast, in the traffic analyzer 1 in accordance with the present invention, since the traffic data of each passenger regarding when and what floor the passenger gets on the elevator and then when and what floor the passenger gets off the elevator can be stored and retrieved accurately, the flow of the passengers in the building in a given period of time can be accurately analyzed without creating a virtual data of passenger flow.

Thus, by using the accurate analytical results, the performance of the elevator can be improved (Step 5). For example, analyzing the actual flow of the passengers in a predetermined period can help to improve parameters and software of the group management control system of the researched elevators, change the group control program itself, or even when replacing existing old elevator system. Such improvements can result in substantial improvements in operation performance and shortening of the passenger waiting time.

Furthermore, when replacing the existing elevator to a new elevator system, using the traffic data analyzed according to the present invention can help to propose the best elevator system to a building owner or a building administrative company that is suitable for use conditions.

While the present invention has been particularly shown and described with reference to the exemplary embodiments as illustrated in the drawings, it will be recognized by those skilled in the art that various modifications may be made without departing from the spirit and scope of the invention as disclosed in the accompanying claims.

1. A building traffic analyzer for an elevator, comprising:
a video camera arranged in an elevator car;
a traffic analyzer unit for collecting traffic data of passengers through the video camera, the traffic analyzer unit being configured to identify and track each passenger for collecting the traffic data of each passenger including a boarding floor with boarding time and a destination floor with exiting time; and
a data storage unit for storing the traffic data of passengers collected by the traffic analyzer unit.

2. The building traffic analyzer of claim 1, wherein the video camera is an existing surveillance camera disposed on the ceiling of the elevator car, and the traffic analyzer unit is connected to the existing surveillance camera.

3. The building traffic analyzer of claim 2, wherein the traffic analyzer unit is connected between the existing surveillance camera and a video recorder of the surveillance camera via splitter.

4. The building traffic analyzer of claim 1, wherein the traffic analyzer is connected to a control panel in the elevator car through a wiring in order to obtain position information of the elevator car from the control panel.

5. The building traffic analyzer of claim 1, wherein the traffic analyzer further comprises a sensor for obtaining position information of the elevator car.

6. The building traffic analyzer of claim 5, wherein the sensor is an atmospheric pressure sensor.

7. The building traffic analyzer of claim 1, wherein the video camera is a three-dimensional camera.

8. A method of analyzing a flow of passengers in a building using a building traffic analyzer for an elevator, the building traffic analyzer including a traffic analyzer unit for collecting traffic data of passengers through a video camera, and a data storage unit for storing the traffic data of passengers collected by the traffic analyzer unit, comprising the steps of:
installing the building traffic analyzer in an elevator car;
collecting traffic data of each passenger for a predetermined period of time by identifying and tracking the each passenger through the video camera, the traffic data including a boarding floor with boarding time and a destination floor with exiting time;
storing the traffic data of each passenger in the data storage unit;
extracting the traffic data from the data storage unit; and
analyzing actual traffic flow of the passengers in a building based on the traffic data.

9. The method of claim 8, wherein the video camera is an existing surveillance camera in the elevator car, and the step of installing the building traffic analyzer further includes connecting the building traffic analyzer to the existing surveillance camera in the elevator car.

10. The method of claim 9, further comprising the step of: connecting the traffic analyzer unit between the existing surveillance camera and a video recorder of the surveillance camera via splitter.

11. The method of claim 8, wherein the step of installing the building traffic analyzer further includes:
connecting the building traffic analyzer to a control panel in the elevator car; and
obtaining position information of the elevator car from the control panel.

12. The method of claim 8, wherein the step of analyzing the actual traffic flow of the passengers in a building further comprises inputting the traffic data to an external computer for simulation.

13. The method of claim 8, wherein the traffic analyzer further comprises an atmospheric pressure sensor for obtaining position information of the elevator car.

14. The method of claim 8, wherein the step of collecting traffic data of each passenger for a predetermined period of time includes collecting the traffic data for one week.
